(19) United States
(12) Patent Application Publication
(10) Pub. No.: US 2021/0047025 A1
(43) Pub. Date: Feb. 18, 2021

(54) Landing Gear Device

(71) Applicant: Michael Roach, French Lick, IN (US)

(72) Inventor: Michael Roach, French Lick, IN (US)

(21) Appl. No.: 16/538,931

(22) Filed: Aug. 13, 2019

(51) Int. Cl. B64C 25/32; B64C 27/04

(52) U.S. Cl. CPC B64C 25/32; B64C 2025/325; B64C 27/04

(57) ABSTRACT

A landing gear device for reducing crash landings includes a mounting assembly that is configured to couple to a bottom of a vertical take-off and landing aircraft, such as a remotely controlled helicopter. Each of a plurality of rods, which are resiliently flexible, is coupled to and extends transversely from the mounting assembly to define a pyramid, with the mounting assembly being positioned at an apex of the pyramid. The plurality of rods is configured to reduce a frequency of crash landings of the vertical take-off and landing aircraft.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to landing gear devices and more particularly pertains to a new landing gear device for reducing crash landings.

### (2) Description of Related Art Including Information Disclosed Under 37 CFR 1.97 and 1.98

The prior art relates to landing gear devices.

### BRIEF SUMMARY OF THE INVENTION

An embodiment of the disclosure meets the needs presented above by generally comprising a mounting assembly that is configured to couple to a bottom of a vertical take-off and landing aircraft, such as a remotely controlled helicopter. Each of a plurality of rods, which are resiliently flexible, is coupled to and extends transversely from the mounting assembly to define a pyramid, with the mounting assembly being positioned at an apex of the pyramid. The plurality of rods is configured to reduce a frequency of crash landings of the vertical take-off and landing aircraft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a landing gear device according to an embodiment of the disclosure.

FIG. 2 is a top view of an embodiment of the disclosure.

FIG. 3 is a side view of an embodiment of the disclosure.

FIG. 4 is an exploded view of an embodiment of the disclosure.

FIG. 5 is a side view of an embodiment of the disclosure.

FIG. 6 is a bottom view of an embodiment of the disclosure.

FIG. 7 is a detail view of an embodiment of the disclosure.

### DETAILED DESCRIPTION OF THE INVENTION

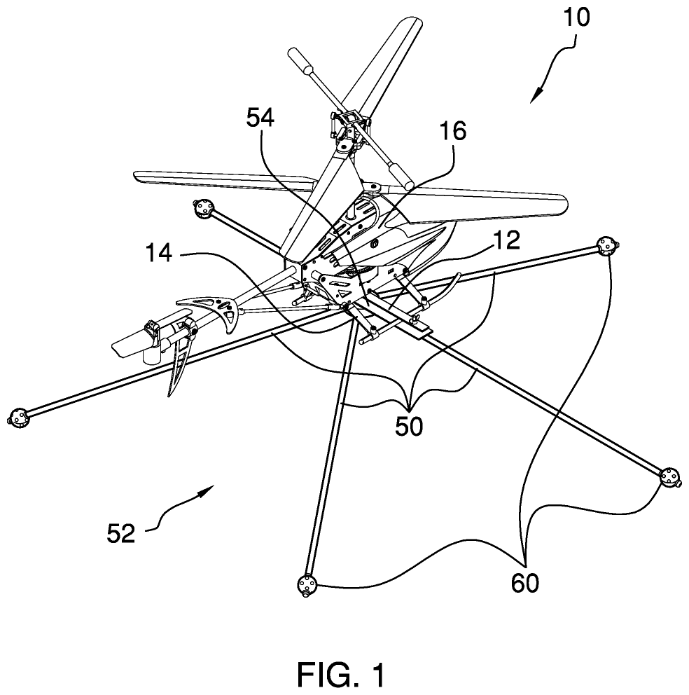

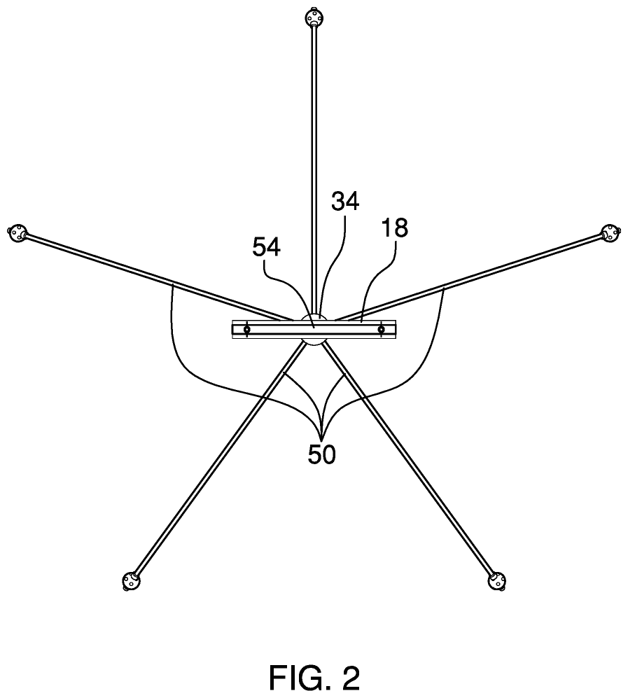

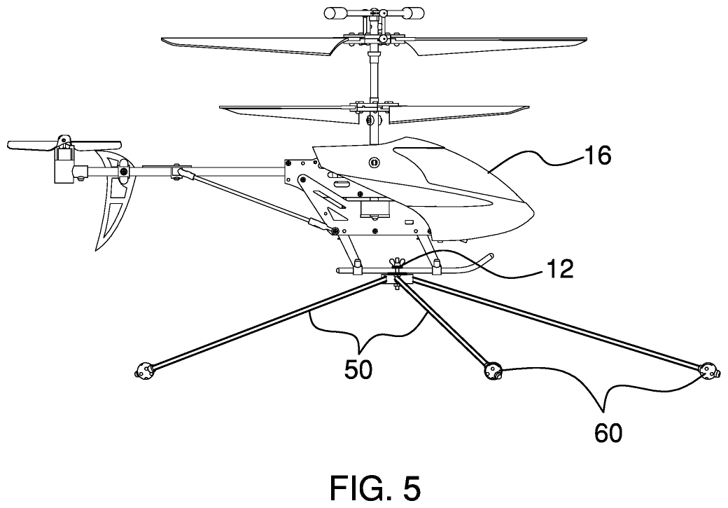

With reference now to the drawings, and in particular to FIGS. 1 through 7 thereof, a new landing gear device embodying the principles and concepts of an embodiment of the disclosure and generally designated by the reference numeral 10 will be described.

As best illustrated in FIGS. 1 through 7, the landing gear device 10 generally comprises a mounting assembly 12 that is configured to couple to a bottom 14 of a vertical take-off and landing aircraft 16, such as a remotely controlled helicopter, drone, and the like. The mounting assembly 12 comprises a beam 18 that is configured to couple to a skid assembly of the vertical take-off and landing aircraft 16 so that the beam 18 extends between landing skids of the skid assembly. The beam 18 comprises an upper bar 20 and a lower bar 22. The beam 18 may comprise metal, or other rigid material, such as, but not limited to, wood, plastic, and the like. The beam 18 may comprise aluminum, or other lightweight metal, such as, but not limited to, titanium and the like.

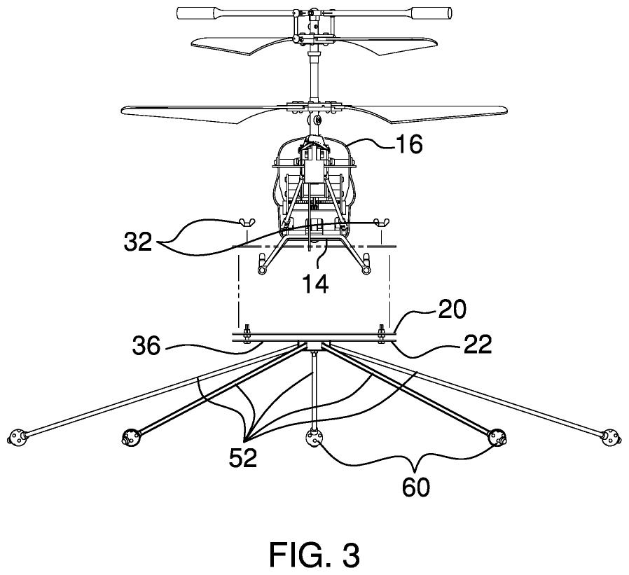

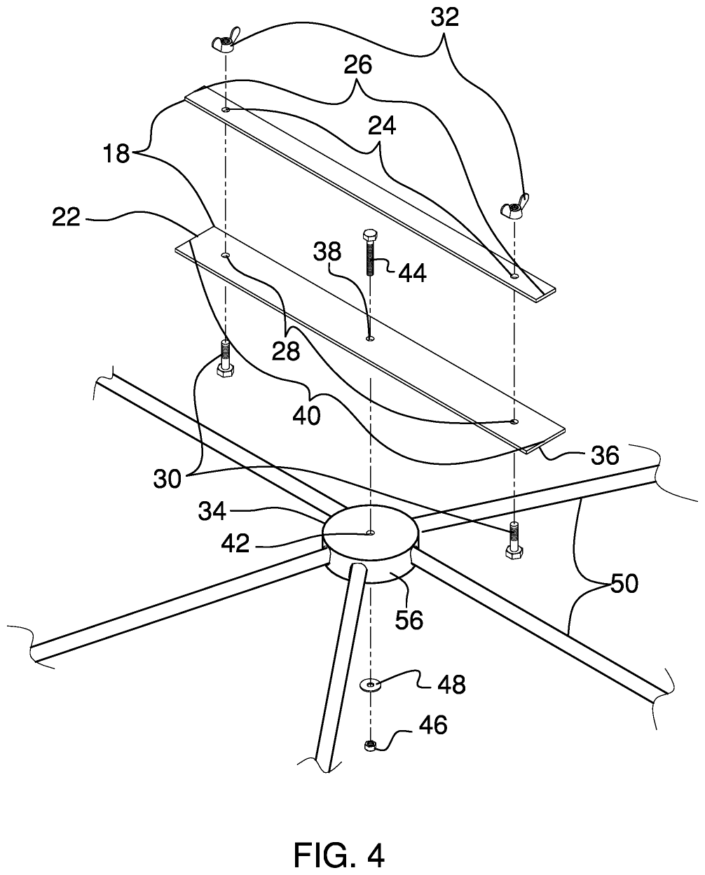

Each of a pair of first holes 24 is positioned in the upper bar 20 proximate to a respective opposing end 26 of the upper bar 20. Each of a pair of second holes 28 is positioned in the lower bar 22 so that the pair of second holes 28 is alignable with the pair of first holes 24. Each of a pair of mounting bolts 30 is selectively insertable into a respective first hole 24 and a respective second hole 28. Each of a pair of wing nuts 32 is selectively threadedly couplable to a respective mounting bolt 30 to removably couple the mounting assembly 12 to the skid assembly of the vertical take-off and landing aircraft 16, as shown in FIGS. 3 and 4. The present invention anticipates other coupling means for coupling the mounting assembly 12 to the skid assembly, such as, but not limited to, straps, quick connects, clamps, and the like.

A disc 34 is coupled to a lower face 36 of the beam 18. The disc 34 is coupled to the lower bar 22. An orifice 38 is positioned in the lower bar 22 equally distant from opposing termini 40 of the lower bar 22. A bore hole 42 extends axially through the disc 34. A coupling bolt 44 is selectively insertable through the orifice 38 and the bore hole 42. A coupling nut 46 is selectively threadedly couplable to the coupling bolt 44 to removably couple the disc 34 to the lower bar 22, as shown in FIG. 4. A washer 48 is selectively positionable between the coupling nut 46 and the disc 34. The washer 48 is configured to facilitate tightening of the coupling nut 46. The present invention anticipates other coupling means for coupling the disc 34 to the lower bar 22, such as, but not limited to, adhesives, welds, screws, and the like.

Each of a plurality of rods 50, which are resiliently flexible, is coupled to and extends transversely from the mounting assembly 12 to define a pyramid 52, with the mounting assembly 12 being positioned at an apex 54 of the pyramid 52, as shown in FIG. 3. The plurality of rods 50 extends from the disc 34 and the rods 50 are substantially equally spaced around a perimeter 56 of the disc 34.

The plurality of rods 50 is configured to reduce a frequency of crash landings of the vertical take-off and landing aircraft 16. The device 10 is particularly useful for a novice operator who is learning to land the vertical take-off and landing aircraft 16. Crash landings often cause damage of the vertical take-off and landing aircraft 16, leading to frustration, costs for repair, and lost time. The device 10 also is useful in positioning the vertical take-off and landing aircraft 16 on a surface for testing.

The plurality of rods 50 comprises from three to seven rods 50. The plurality of rods 50 may comprise five rods 50. The rods 50 may comprise fiberglass, or other resiliently flexible material, such as, but not limited to, wood, bamboo, nylon, plastic, and the like.

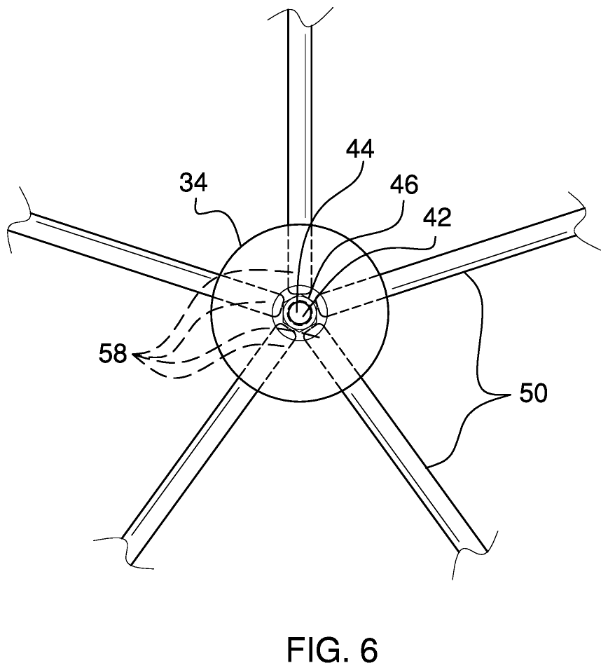

Each of a plurality of channels 58 extends transversely into the disc 34 from the perimeter 56 of the disc 34, as shown in FIG. 6. A respective rod 50 is selectively insertable into the channel 58 so that the respective rod 50 is frictionally and removably coupled to the disc 34.

Each of a plurality of feet 60 is coupled to a respective rod 50 distal from the mounting assembly 12. The plurality of feet 60 is configured to stabilize the vertical take-off and landing aircraft 16 on the surface. The feet 60 are spherically shaped and hollow. The feet 60 may comprise plastic, or other material, such as, but not limited to, rubber, silicone, wood, and the like.

Each of a plurality of apertures 62 is positioned in a respective foot 60 so that the plurality of apertures 62 is positioned to reduce a mass of the plurality of feet 60. An aligned pair of apertures 64 is positioned to insert a respective rod 50 through a respective foot 60.

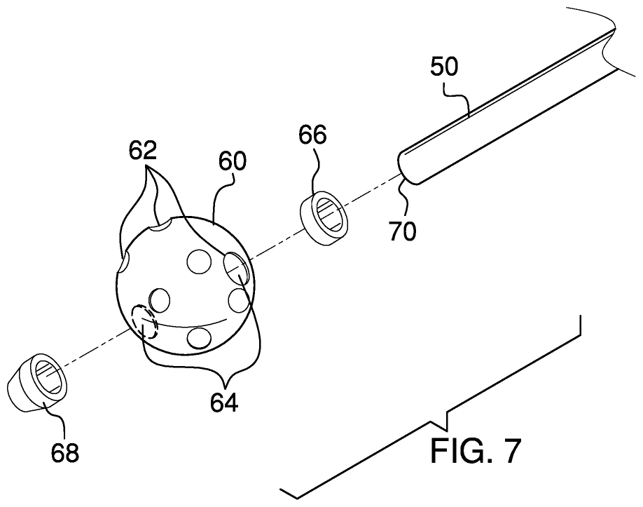

Each of a plurality of rings 66 is positioned to selectively insert a respective rod 50 so that the ring 66 is frictionally coupled to the respective rod 50 distal from the mounting assembly 12. Each of a plurality of push nuts 68 is selectively couplable to an endpoint 70 of a respective rod 50 to removably couple a respective foot 60 to the respective rod 50 between the push nut 68 and an associated ring 66, as shown in FIG. 7. The present invention anticipates other fastening means for fastening the feet 60 to the rods 50, such as, but not limited to, glues, spring loaded pins, and the like.

In use, the mounting assembly 12 is coupled to the vertical take-off and landing aircraft 16 using the mounting bolts 30 and wing nuts 32. The rods 50 are inserted into the channels 58 so that the mounting assembly 12 and the vertical take-off and landing aircraft 16 are positioned at the apex 54 of the pyramid 52 that is defined by the plurality of rods 50. The device 10 thus is configured to reduce the frequency of crash landings of the vertical take-off and landing aircraft 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A landing gear device comprising:
a mounting assembly configured for coupling to a bottom of a vertical take-off and landing aircraft; and
a plurality of rods, the rods being resiliently flexible, each rod being coupled to and extending transversely from the mounting assembly defining a pyramid with the mounting assembly being positioned at an apex of the pyramid wherein the plurality of rods is configured for reducing a frequency of crash landings of the vertical take-off and landing aircraft.

2. The device of claim 1, further including the mounting assembly comprising:
a beam configured for coupling to a skid assembly of the vertical take-off and landing aircraft such that the beam extends between landing skids of the skid assembly; and
a disc coupled to a lower face of the beam, the plurality of rods extending from the disc, the rods being substantially equally spaced around a perimeter of the disc.

3. The device of claim 2, further including the beam comprising metal.

4. The device of claim 3, further including the beam comprising aluminum.

5. The device of claim 2, further comprising:
the beam comprising an upper bar and a lower bar, the disc being coupled to the lower bar;
a pair of first holes positioned in the upper bar, each first hole being positioned proximate to a respective opposing end of the upper bar;
a pair of second holes positioned in the lower bar such that the pair of second holes is alignable with the pair of first holes;
a pair of mounting bolts, each mounting bolt being selectively insertable into a respective first hole and a respective second hole; and
a pair of wing nuts, each wing nut being selectively threadedly couplable to a respective mounting bolt for removably coupling the mounting assembly to the skid assembly of the vertical take-off and landing aircraft.

6. The device of claim 5, further comprising:
an orifice positioned in the lower bar equally distant from opposing termini of the lower bar,
a bore hole extending axially through the disc;
a coupling bolt selectively insertable through the orifice and the bore hole;
a coupling nut selectively threadedly couplable to the coupling bolt for removably coupling the disc to the lower bar; and
a washer selectively positionable between the coupling nut and the disc wherein the washer is configured for facilitating tightening of the coupling nut.

7. The device of claim 1, further including the plurality of rods comprising from three to seven rods.

8. The device of claim 7, further including the plurality of rods comprising five rods.

9. The device of claim 1, further including the rods comprising fiberglass.

10. The device of claim 2, further including a plurality of channels, each channel extending transversely into the disc from the perimeter of the disc, a respective rod being selectively insertable into the channel such that the respective rod is frictionally and removably coupled to the disc.

11. The device of claim 1, further including a plurality of feet, each foot being coupled to a respective rod distal from the mounting assembly wherein the plurality of feet is configured for stabilizing the vertical take-off and landing aircraft on a surface.

12. The device of claim 11, further including the feet being spherically shaped, the feet being hollow.

13. The device of claim 11, further including the feet comprising plastic.

14. The device of claim 12, further including a plurality of apertures, each aperture being positioned in a respective foot such that the plurality of apertures is positioned for reducing a mass of the plurality of feet and such that an aligned pair of apertures is positioned for inserting a respective rod through a respective foot.

15. The device of claim 14, further comprising:
a plurality of rings, each ring being positioned for selectively inserting a respective rod such that the ring is frictionally coupled to the respective rod distal from the mounting assembly; and
a plurality of push nuts, each push nut being selectively couplable to an endpoint of a respective rod for removably coupling a respective foot to the respective rod between the push nut and an associated ring.

16. A landing gear device and vertical take-off and landing aircraft combination comprising:
a vertical take-off and landing aircraft;
a mounting assembly configured for coupling to a bottom of the vertical take-off and landing aircraft; and
a plurality of rods, the rods being resiliently flexible, each rod being coupled to and extending transversely from the mounting assembly defining a pyramid with the mounting assembly being positioned at an apex of the pyramid wherein the plurality of rods is configured for reducing a frequency of crash landings of the vertical take-off and landing aircraft.

17. A landing gear device comprising:
a mounting assembly configured for coupling to a bottom of a vertical take-off and landing aircraft, the mounting assembly comprising:
a beam configured for coupling to a skid assembly of the vertical take-off and landing aircraft such that the beam extends between landing skids of the skid assembly, the beam comprising an upper bar and a lower bar, the beam comprising metal, the beam comprising aluminum,
a pair of first holes positioned in the upper bar, each first hole being positioned proximate to a respective opposing end of the upper bar,
a pair of second holes positioned in the lower bar such that the pair of second holes is alignable with the pair of first holes,
a pair of mounting bolts, each mounting bolt being selectively insertable into a respective first hole and a respective second hole,
a pair of wing nuts, each wing nut being selectively threadedly couplable to a respective mounting bolt for removably coupling the mounting assembly to the skid assembly of the vertical take-off and landing aircraft,
a disc coupled to a lower face of the beam, the disc being coupled to the lower bar,
an orifice positioned in the lower bar equally distant from opposing termini of the lower bar,
a bore hole extending axially through the disc,
a coupling bolt selectively insertable through the orifice and the bore hole,
a coupling nut selectively threadedly couplable to the coupling bolt for removably coupling the disc to the lower bar, and
a washer selectively positionable between the coupling nut and the disc wherein the washer is configured for facilitating tightening of the coupling nut;
a plurality of rods, the rods being resiliently flexible, each rod being coupled to and extending transversely from the mounting assembly defining a pyramid with the mounting assembly being positioned at an apex of the pyramid wherein the plurality of rods is configured for reducing a frequency of crash landings of the vertical take-off and landing aircraft, the plurality of rods comprising from three to seven rods, the plurality of rods comprising five rods, the rods comprising fiberglass, the plurality of rods extending from the disc, the rods being substantially equally spaced around a perimeter of the disc;
a plurality of channels, each channel extending transversely into the disc from the perimeter of the disc, a respective rod being selectively insertable into the channel such that the respective rod is frictionally and removably coupled to the disc;
a plurality of feet, each foot being coupled to a respective rod distal from the mounting assembly wherein the plurality of feet is configured for stabilizing the vertical take-off and landing aircraft on a surface, the feet being spherically shaped, the feet being hollow, the feet comprising plastic;
a plurality of apertures, each aperture being positioned in a respective foot such that the plurality of apertures is positioned for reducing a mass of the plurality of feet and such that an aligned pair of apertures is positioned for inserting a respective rod through a respective foot;
a plurality of rings, each ring being positioned for selectively inserting a respective rod such that the ring is frictionally coupled to the respective rod distal from the mounting assembly; and
a plurality of push nuts, each push nut being selectively couplable to an endpoint of a respective rod for removably coupling a respective foot to the respective rod between the push nut and an associated ring.
